(19) United States
(12) Patent Application Publication
(10) Pub. No.: US 2010/0252228 A1
(43) Pub. Date: Oct. 7, 2010

(54) Geothermal System

(75) Inventor: Franz-Josef Püttmann, Lennestadt (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Tracto-Technik GmbH & Co. KG, Lennestadt (DE)

(21) Appl. No.: 12/742,563

(22) PCT Filed: Nov. 13, 2008
(86) PCT No.: PCT/EP2008/009614

§ 371 Date: May 12, 2010

(30) Foreign Application Priority Data
Nov. 13, 2007 (DE) 10 2007 054 472.5

(51) Int. Cl. F24J 3/08; F28D 7/12; B23P 6/00

(52) U.S. Cl. 165/45; 165/156; 29/890.031

(57) ABSTRACT

The invention relates to a geothermal system for exchanging heat with the water of a public supply line, wherein the heat exchanger is arranged within the supply line and is used in modular form as a pipe section.

The invention relates to a geothermal system providing heat exchange with the water of the public water supply network and claims the priority of the German patent application 10 2007 054 472.5-15.

The development of geothermal energy has recently gained increased significance. In particular, supply of geothermal energy is of increasing commercial interest for large public installations and building complexes due to the increasing energy costs.

When using geothermal heat with a heat pump which transfers, during heating with a heat pump, the cold temperature via a heat exchanger, deep vertical or large area horizontal holes are currently drilled in the ground, in which geothermal probes are placed.

For example, DE 199 19 555 C1 discloses a method for developing geothermal energy, wherein a drill hole is introduced into the ground with a steered vertical drilling device. The drill head of the vertical drilling device has a temperature sensor which measures the temperature in the surrounding ground. The drilling path is then controlled as a function of the temperature in the ground. A heat exchange pipe (geothermal probe), through which a heat exchange medium flows, is subsequently inserted into the drilled hole. The heat exchange medium takes up the geothermal energy which is then provided via a heat exchanger for additional use.

With methods that introduce essentially horizontal drill holes into the ground, heat exchangers are either installed in open construction over a large area, or holes are drilled into the ground at an angle starting from the surface, continuing in a horizontal direction after reaching a certain depth. Alternatively, horizontal holes can be drilled from a trench with an uncontrolled horizontal drilling device.

Typically, the vertical drill holes must have a significant depth in order to be able to provide the necessary surface for heat exchange. This results in high installation costs for such systems.

Disadvantageously, horizontally extending geothermal probes installed at shallow depths have a low heat output due to the lower temperatures in the ground layers near the surface. In order to nevertheless obtain sufficient thermal energy, a large number of directly adjacent geothermal probes are usually introduced, which also results in high installation costs. These high costs presently prevent a widespread supply of geothermal energy, in particular in cities.

EP 1 003 968 describes a technology where existing drinking water pipes are used as a heat reservoir. This makes it possible to supply the cold temperature generated with a heat pump to an already existing medium which is in continuous exchange, without the need to establish expensive drill holes across an area or deep holes. However, this technology has so far not met with success. A similar system is described in DE 28 34 442 A1.

Starting from the present state of the technology, it is an object of the invention to provide a method and a device for optimizing and/or a simplifying heat exchange with the public water supply network and preventing water contamination.

The object is solved by a method and a geothermal system according to the independent claims. Advantageous embodiments are recited in the dependent claims.

The invention is based on the concept to provide a geothermal system with a heat exchanger in form of pipe sections that can be easily installed in the public supply network, or in form of a heat exchanger disposed inside pipe sections. The pipe section itself may be constructed as a heat exchanger.

Preferably, the cross-section of the drinking water line is not narrowed. The pipe section may have a larger outside diameter than the drinking water pipe and may be connected with the drinking water line by way of a collar.

The heat exchanger may have heat exchanger lines arranged parallel to the flow direction of the water and may, in a simple embodiment, be configured merely as an interior pipe located inside the drinking water pipe. Alternatively, the lines may change their direction once or several times so that the heat exchange medium changes its direction several times when flowing through the pipes, flowing alternatingly upstream and downstream. In addition, heat-conducting structures may be provided, including a casing which lines the wall of the supply line.

The heat exchanger may be arranged inside the pipe section in spiral form. Its configuration can additionally cause vortices in the water which improve heat exchange, as is the case, for example, when the axis of the spiral is oriented differently from the axis of the supply line. The following spiral section is then not located in the “shadow” of the preceding section.

Heat exchangers can hence be employed in modular form for installation in an existing public pipe network or a public pipe network to be constructed. The heat exchanger may be inserted in the supply line as a separate unit or may be a component of the supply line. The supply line may hence also be initially provided with heat exchangers.

Within the context of the invention, the terms “public line” or “supply line” are not limited to deployment in public supply networks, but are rather meant to express the type of the line that transports a water volume sufficient for heat exchange.

If a heat pump is installed, for example in an apartment building, then the pipe section of the supply line located in front of the building may be replaced with a pipe section having a heat exchanger according to the invention. Alternatively, according to the invention, a heat exchanger may be initially installed in the public supply line which then only needs to be connected to the heat pump. The prefabricated pipe section with integrated heat exchanger provides quality control and reproducible efficiency and is easy to install.

The heat exchanger and line may therefore be installed during the initial installation of the drinking water supply or inserted later. When inserted later, the heat exchanger can also be introduced into the pipe through an existing access. This can be accomplished, for example, with a shaft, into which the heat exchanger is lowered and then moved horizontally to the height of an existing fitting for the heat pump or to a fitting to be installed. The heat exchanger then needs only be connected with the feed and return lines of the heat pump.

Alternatively, an existing pipe section may be removed and replaced with a pipe section having a heat exchanger and an already installed fitting for a line of a heat pump.

The line of the heat pump itself can also be constructed as a heat exchanger. In this way, additional heat can be removed from the ground on the feed path to the water pipe and on the return path to the heat exchanger, because according to the invention, a closed flow loop is provided between the heat exchanger and the drinking water line.

With the method of the invention, a geothermal system may be installed cost-effectively in an existing line or planned for new construction, without causing contamination of the drinking water during installation or during operation. The heat exchanger has a separate flow loop for the medium, thus preventing contact between the flow loop for the medium and the supply water. The corresponding regulatory requirements for the drinking water unit can therefore be satisfied.

The water flowing through a typical drinking water pipe has a large heat capacity. Typically, the water has a temperature of 10° C. with variations depending on the season. A flow loop for the medium which runs, on one hand, through the heat pump and, on the other hand, through the drinking water transports the medium back and forth between the heat pump and the drinking water line, whereby for heating purposes the medium is cooled to, for example, 3° C. by withdrawing heat in the heat pump and then heated again to 9° C. in the drinking water.

The flow loop for the medium can be controlled or regulated so that the flow velocity allows optimal heat removal and can be adapted to the seasonally changing temperatures. In addition, a regulator may prevent the temperature of the drinking water from dropping to less than 0° C. to prevent formation of ice. However, the transport medium may be cooled to less than 0° C., because this does not necessarily cause cooling of the drinking water to less than 0° C.

Separately, the feed line to the drinking water pipe and/or the return line to the heat pump may be constructed to provide additional heat exchange. This can also be implemented by interconnecting elements having additional surface area, or with conventional horizontal or vertical heat exchangers, provided there is sufficient space, as well as through other measures for additional heat recovery. The aforedescribed principles may also be used during the summer in conjunction with an air-conditioning unit for cooling the medium or the user system.

The flowing supply water as the heat exchange medium absorbs and removes the cold temperature supplied from the heat pump via the flow loop for the medium at the heat exchanger. On the subsequent flow path of the water, for example to the next tapping location, the water transfers the cold temperature to the ground and/or regains its original temperature. The decrease in temperature is small due to the volume of the supply water, thereby eliminating the risk of adversely affecting the water supply through formation of ice. Advantageously, the temperature decrease also reduces the bacteria count in the water.

However, the heat transfer from the ground to the supply line may also be used to increase the temperature of the drinking water and hence the efficiency of the heat exchanger. The supply line may here consist of at least in a section (e.g., a later installed pipe section) preferably made of a material having high heat conductivity. For example, metals and in particular stainless steel are suitable materials; alternative materials are plastics, in particular a particle- and/or fiber-reinforced plastic (e.g., with metal and/or carbon particles or fibers). This can improve heat transfer from the ground to the drinking water. Alternatively, a supply line made of a corrosion-resistant material may be used, thereby eliminating the otherwise typical interior liner made of concrete and the exterior liner made of bitumen. Insulation caused by the two liners can thereby be prevented.

Preferably, the supply line may include fins disposed at least along a section of its outer and/or inner surface. These fins increase the contact surface between the supply line and the ground and/or the drinking water, which also improves heat transfer. The fins may preferably be oriented radially in relation to a supply line having a circular cross section.

Moreover, the supply line may be encased in the relevant section(s) with a fill material providing contact between the supply line and the surrounding ground with as little play as possible. To further improve heat transfer, the fill material should have very high heat conductivity. A suitable fill material is, for example, conventional thermo-concrete. A later encapsulation of the supply line with the fill material may be advantageous, in particular, if a pipe section having the heat exchanger is subsequently introduced by way of a trench-less pipe laying method (e.g., pipe bursting). By subsequently compressing the fill material, the ground surrounding the supply line is compressed at the same time, thereby also improving its heat conductivity.

A corresponding embodiment of the supply line should be generally used only if the average temperature of the ground is higher than the average temperature of the drinking water.

Heat exchange between the drinking water and the ground can also be improved by designing the drinking water pipe in those sections that are located outside the region of the heat exchange with the heat exchange medium, in a way that the heat supplied to the heat exchanger is dissipated by the surrounding ground as quickly as possible, so that heat can be again provided farther downstream to additional geothermal systems. These sections may also be arranged in preferred regions, for example in sections without buildings or in layers carrying water.

The invention will now be described with reference to exemplary embodiments illustrated in the drawings. The drawings show in:

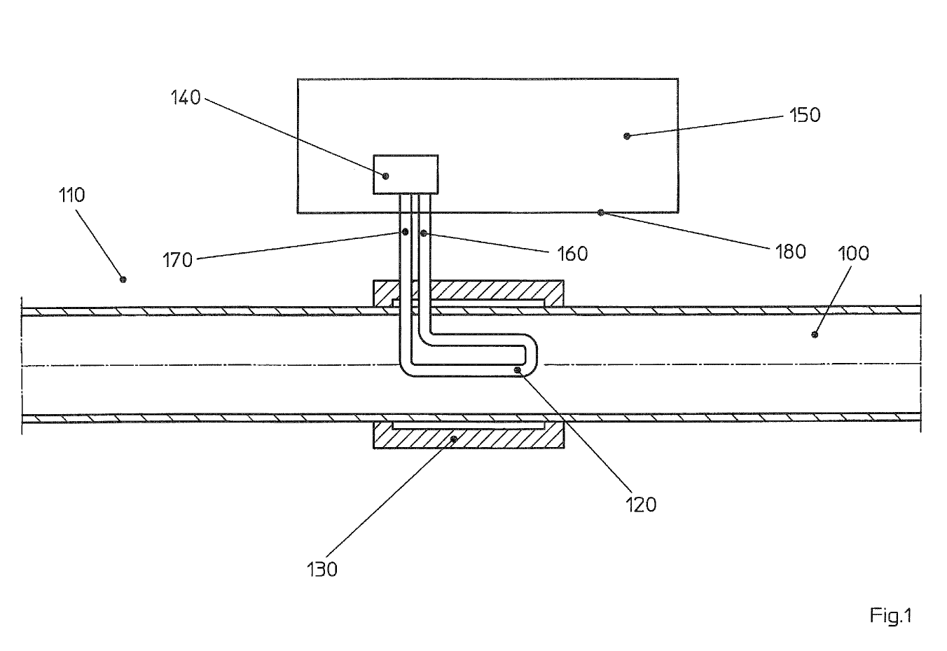

FIG. 1 a schematic diagram of a system according to the invention with a heat exchanger arranged in the supply line;

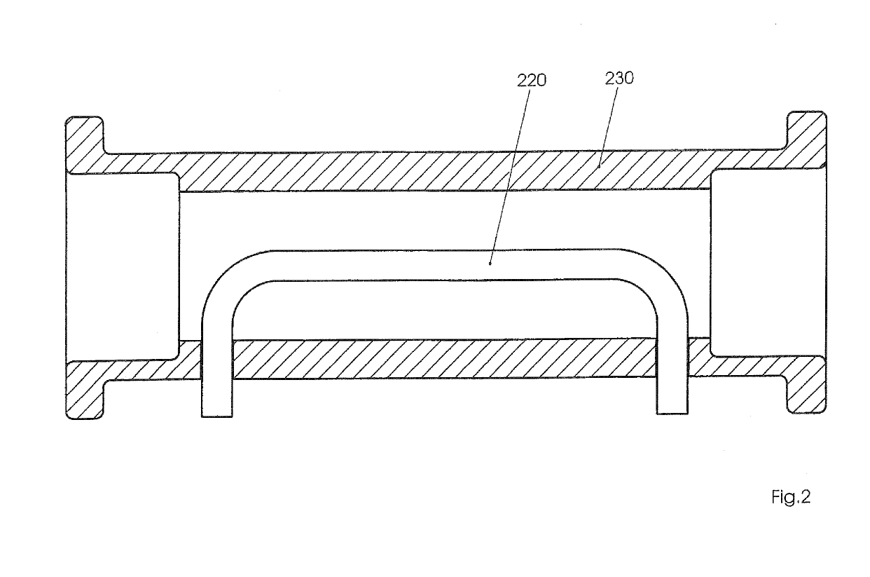

FIG. 2 a simple linear heat exchanger arranged in the supply line;

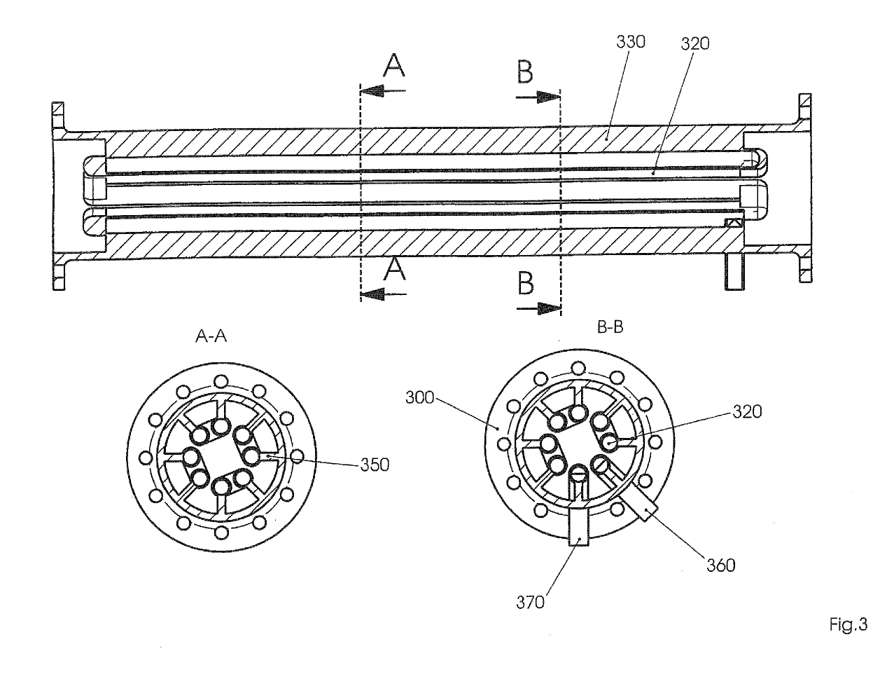

FIG. 3 the heat exchanger of FIG. 1 with several linear elements;

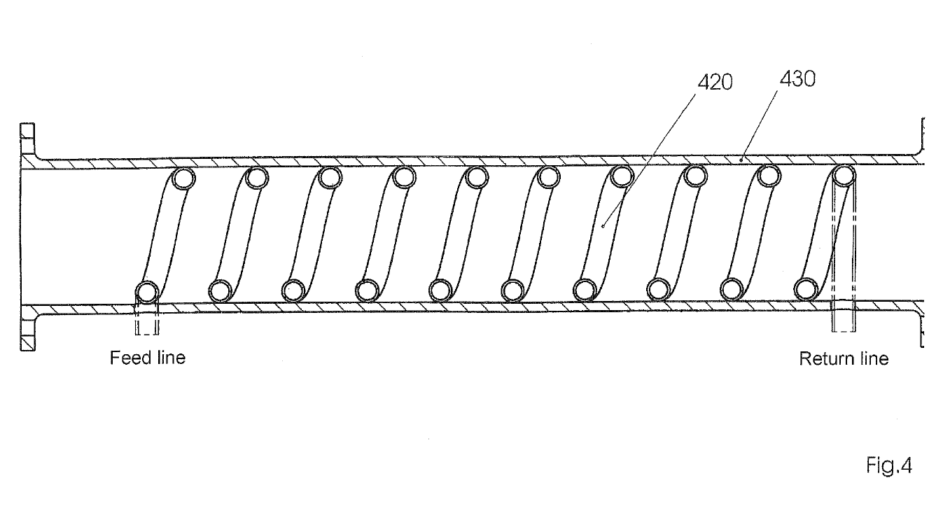

FIG. 4 another exemplary embodiment of a heat exchanger arranged in the supply line having a spiral structure;

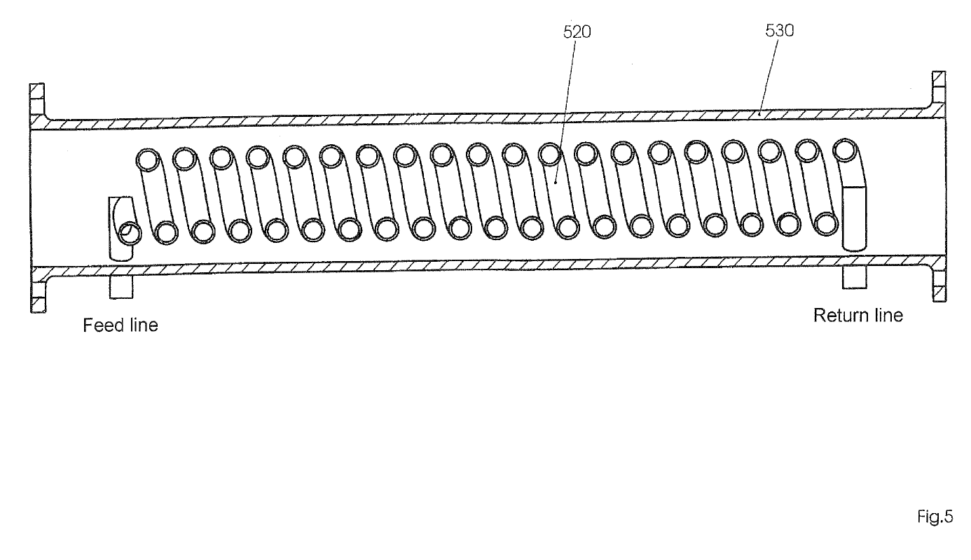

FIG. 5 another embodiment of the heat exchanger of FIG. 3;

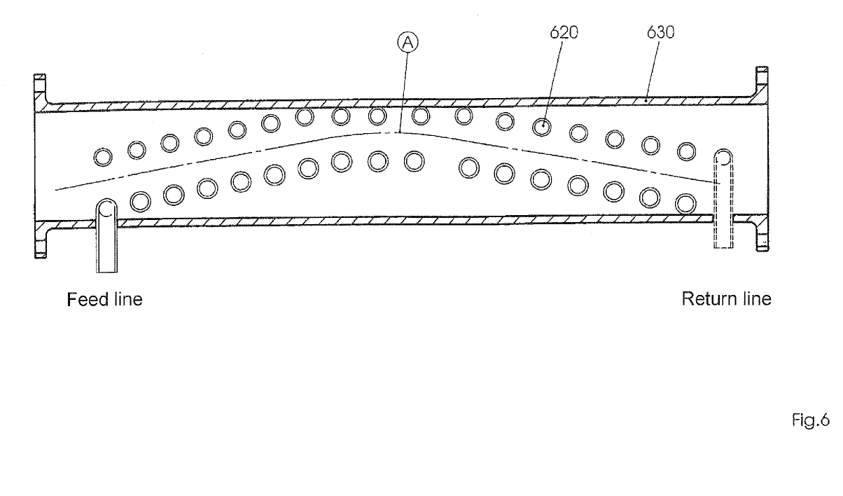

FIG. 6 a heat exchanger of FIG. 3 having an axial orientation different from the axis of the water line;

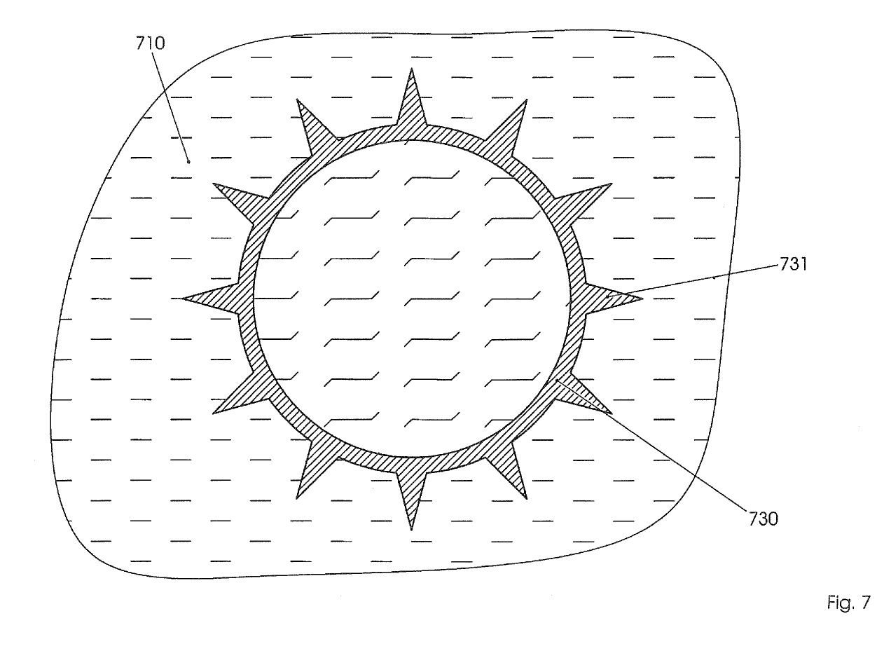

FIG. 7 in cross-section, a first embodiment of a supply line configured for improved heat exchange with the ground;

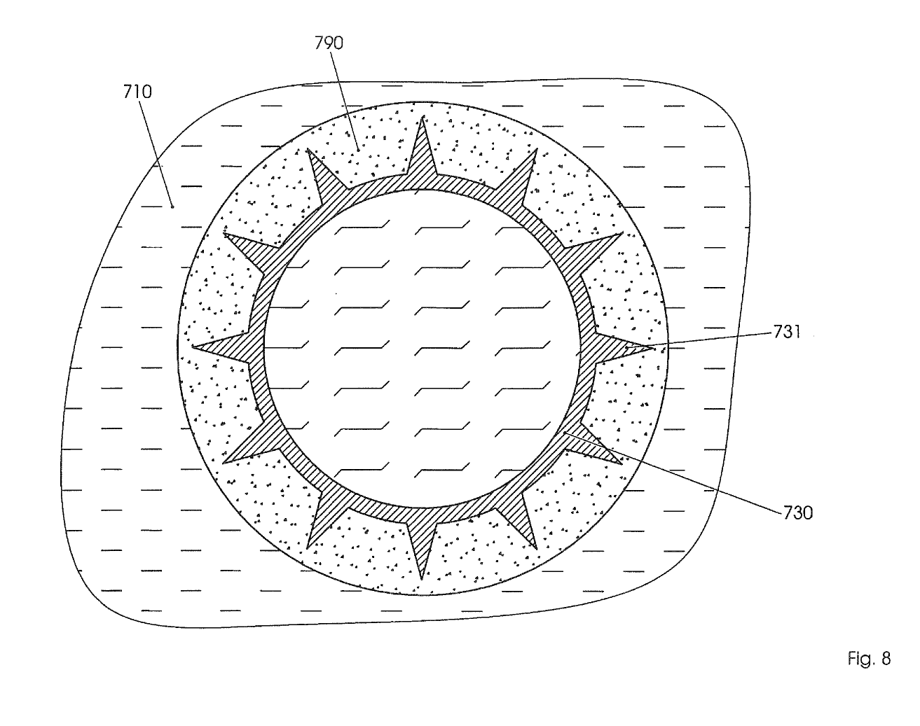

FIG. 8 the supply line of FIG. 7 with casing;

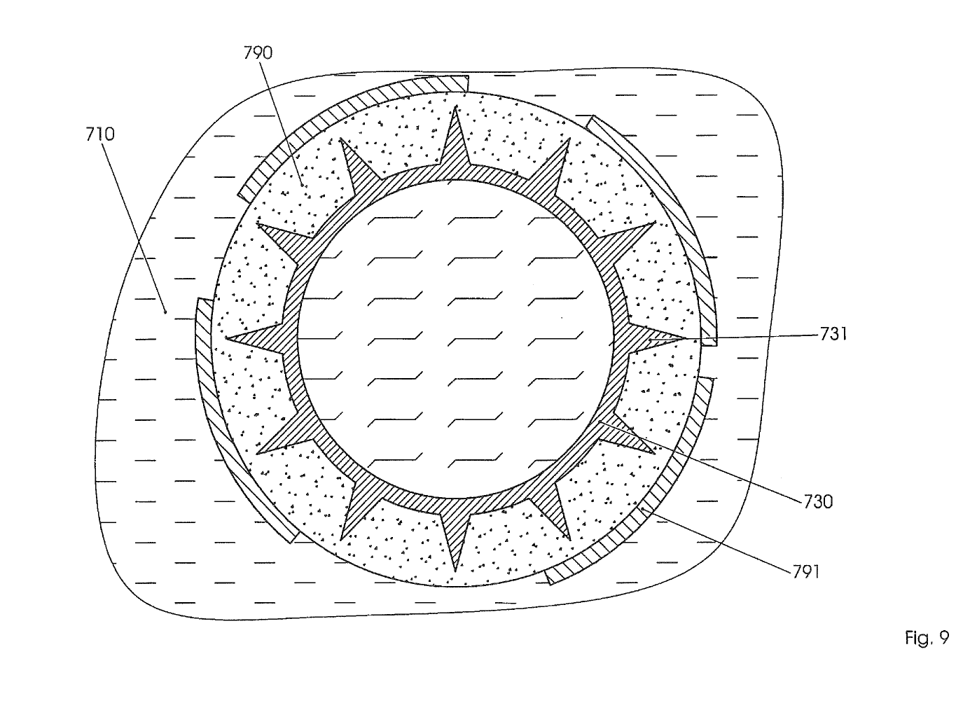

FIG. 9 the supply line of FIG. 7 with a casing applied after installation by way of pipe bursting; and

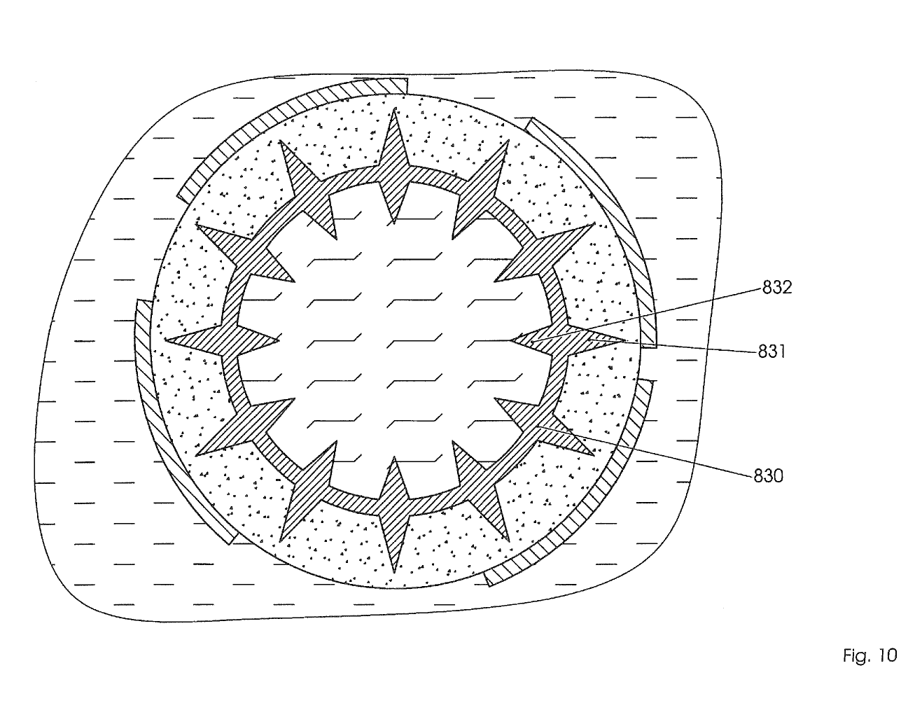

FIG. 10 in cross-section, a second embodiment of a supply line designed for improved heat exchange with the ground.

A public water line 100 runs proximate to a building 150. A heat pump 140, which includes a recirculating line 160, 170 with a loop for a cooling medium, is arranged inside the building 150. The recirculating line 160, 170 runs from the heat pump 140 through the building wall 180 and the adjacent ground 110 to the water line 100 where it terminates in a heat exchanger 120 arranged in a modular pipe section 130. The heat exchanger 120 is in direct contact with the water of the public water line 100, thereby enabling transfer of the (lower) temperature of the heat pump medium to the wall of the heat exchanger 120 and finally to the flowing water. As a result, the medium is heated, and this heat can be converted in the heat pump into heat output.

In the aforedescribed embodiment, a pipe section 130 can be introduced as a module and/or later in a water line 100. In addition, direct contact between the heat pump medium and the drinking water is prevented.

Introduction of a heat exchanger through a manhole 2 has no effect on the water line 1, except for the connection to the heat pump.

Accordingly, the heat exchanger can be installed in an existing water line without or with only minimal intervention in the integrity of the line and without the risk of contamination of the water.

In the exemplary embodiment illustrated in FIG. 2, the heat exchanger 220 is configured as a linear pipe inside a pipe section 230. This represents a simple cost-effective structure. In FIG. 3, the heat exchanger 320 of FIG. 2 is routed linearly inside the pipe section 330, however in several loops. As seen in the illustrated cross-sections A-A and B-B, the channels of the heat exchanger 320 are arranged on fins 350 which additionally support the heat exchanger. In addition, the pipe can be lined with heat-conducting material. This increases the heat exchange efficiency along the same section in comparison to the embodiment of FIG. 2.

FIG. 4 illustrates an embodiment with a spiral heat exchanger 420 disposed inside a pipe section 430. The surface area per section contacting the water is hereby further increased.

Frequently, the flow cross-section of the water supply line must not be narrowed. In this case, the diameter of the pipe section having the heat exchanger may be dimensioned such that the flow cross-section remains unchanged in spite of insertion of the heat exchanger. More particularly, a heat exchanger 520 according to FIG. 5 can be employed in these situations, which is spaced from the wall of a pipe section 530 to improve heat exchange.

FIG. 6 shows a spiral-shaped heat exchanger 620 having an axis A which is different from the axis of the pipe section 630. This can further improve utilization of the heat capacity of the water, because the temperature shadow of the preceding spiral-shaped section has no effect at all or at least only a reduced effect on the following spiral-shaped section. In addition, vortices are advantageously generated in the water.

The heat exchanger may be already installed when the water line is manufactured and laid together with the water line 1. Alternatively, the heat exchanger may be introduced later in an existing water pipe as a module by exchanging individual pipe segments.

FIGS. 7 to 9 show a first embodiment of a pipe section 730 designed for improved heat transfer from the ground 710 to the drinking water flowing through the supply pipe. The pipe section has a circular cross section and is provided on its exterior surface with radially oriented fins 730 which increase the contact surface between the pipe section 730 and the ground, thereby possibly improving heat transfer from the ground to the drinking water flowing inside the pipe section.

As illustrated in FIGS. 8 and 9, the pipe section 730 is additionally encased with thermo-concrete 790 as a fill material, providing direct contact between the pipe section 730 and the ground 710 and potentially improving heat transfer from the ground to the pipe section and hence also to the drinking water.

FIG. 9 shows in addition broken fragments 791 of a burst old pipe. These can be produced, for example, when a new supply line (or a corresponding pipe section 730), which according to the invention includes a heat exchanger, is exchanged by way of a trench-less laying method (e.g., pipe bursting). The fins 731 disposed on the exterior surface of the pipe section 730 hereby improve not only the heat transfer from the ground to the drinking water, but also protect the pipe section 730 from damage caused by the frequently sharp-edged broken fragments 791.

FIG. 10 shows a pipe section 830 which has, in addition to the fins 831 disposed on the exterior surface, corresponding fins 832 disposed on the interior surface. These are provided to improve heat transfer from the ground to the drinking water by increasing the contact surface area between the pipe section and the drinking water. Optionally, interior fins 832 may not be provided in each section of the supply line, because they may narrow the flow cross-section of the supply line and make an inspection of the supply line by, for example, self-propelled inspection equipment more difficult.

What is claimed is:

1.-19. (canceled)

20. A geothermal system for heat exchange with water of a public water supply line, comprising a heat exchanger constructed as a module and arranged inside the public water supply line.

21. The geothermal system of claim 20, wherein the heat exchanger has a linear configuration and comprises one or several heat exchanger pipes running in parallel.

22. The geothermal system of claim 20, wherein the heat exchanger is constructed as a spiral.

23. The geothermal system of claim 22, wherein the heat exchanger is spaced from a wall of the public water supply line.

24. The geothermal system of claim 22, wherein the heat exchanger has an axis which is different from an axis of the public water supply line.

25. The geothermal system of claim 20, wherein the heat exchanger comprises a feed and a return line and wherein the feed line and a return line are arranged next to one another.

26. The geothermal system of claim 25, wherein the feed line and the return line of the heat exchanger are configured to provide additional heat exchange on a supply and/or return path of a heat exchange medium flowing through the heat exchanger.

27. The geothermal system of claim 26, wherein the feed line and the return line of the heat exchanger configured to provide additional heat exchange on a supply and/or return path of a heat exchange medium are configured as an additional heat exchanger which is installed in the ground with a horizontal or vertical orientation.

28. The geothermal system of claim 20, wherein the heat exchanger is arranged on a heat-conducting support structure or includes an additional heat-conducting structure.

29. The geothermal system of claim 20, further comprising a closed flow loop for a heat-exchange medium, and a controller or regulator for controlling a flow velocity of the heat-exchange medium.

30. The geothermal system of claim 29, wherein the heat-exchange medium is in a liquid state below 0° C.

31. The geothermal system of claim 20, wherein the public water supply line is constructed for improved heat exchange with the ground.

32. The geothermal system of claim 31, wherein the public water supply line is made in at least one section of a material having high heat-conductivity.

33. The geothermal system of claim 31, wherein the public water supply line comprises fins disposed in at least one section on the interior or exterior surface, or both, of the public water supply line.

34. The geothermal system of claim 31, wherein the public water supply line is encased in a fill material having high heat-conductivity.

35. The geothermal system of claim 20, wherein the heat exchanger is preinstalled in the public water supply line before the public water supply line is laid.

36. A method for installing a heat exchanger in a public water supply line, comprising the step of:
providing a module comprising a pipe section and a heat exchanger disposed inside the pipe section, and
interconnecting the module in an existing public water supply line.

37. The method of claim 36, wherein the pipe section is encased in a fill material having high heat-conductivity.

38. A method for installing a heat exchanger in a public water supply line, comprising the step of:
trenchlessly inserting a heat exchanger horizontally into an existing pipe section of a public water supply line from an existing shaft, and
connecting the heat exchanger with a feed line and a return line for a heat exchange medium.
